(19) United States
(12) Patent Application Publication
(10) Pub. No.: US 2015/0195395 A1
(43) Pub. Date: Jul. 9, 2015

(54) Secure Cloud-Based Phonebook

(71) Applicants: Desiree Gina McDowell-White, Los Angeles, CA (US); Gilbert J. Arenas, Los Angeles, CA (US)

(72) Inventors: Desiree Gina McDowell-White, Los Angeles, CA (US); Gilbert J. Arenas, Los Angeles, CA (US)

(21) Appl. No.: 14/148,022

(22) Filed: Jan. 6, 2014

(51) Int. Cl. H04M 1/725; H04W 12/08; H04W 4/16

(52) U.S. Cl. CPC H04M 1/72522; H04W 4/16; H04W 12/08

(57) ABSTRACT

A cloud-based system for securely maintaining phone numbers and contacts. A mobile application residing on a mobile computing device interfaces with a remotely positioned server to provide phonebook capabilities to a single user of the mobile application. Contact information is only maintained on the remote server and any local information is removed when the mobile application is exited or closed. The server only allows one registered user/device to access the remotely stored information at a time and will notify the authorized user of any attempts to access the remote server.

### BACKGROUND OF THE INVENTION

1. Field of the Invention

The present invention relates to phonebooks and, more particularly, to a cloud-based system for securely maintaining phone numbers and contacts.

2. Description of the Related Art

Contact names and telephone numbers stored in a mobile communication device, such as a smartphone, are difficult to secure and often do not remain private. For example, smartphones may be lost, users may forget to use password protection, and smartphones may be hacked via spyware or other malware. Accordingly, there is a need in the art for a secure method of maintaining phone numbers and contacts for use by a smartphone.

### BRIEF SUMMARY OF THE INVENTION

The present invention comprises a cloud-based system for securely maintaining phone numbers and contacts and quickly and easily being able to access and use the phonebook from any other device. A mobile application residing on a mobile computing device interfaces with a remotely positioned server to provide phonebook capabilities to a single user of the mobile application. All contact information is maintained on the remote server and local information residing on a particular mobile device is removed each time the mobile application is exited or closed. Preferably, the server only allows one mobile application to access the remotely stored information at a time and will warn the authorized user of any attempts by others to access the remote server.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a cloud-based system for securely maintaining phone numbers and contacts according to the present invention.

### DETAILED DESCRIPTION OF THE INVENTION

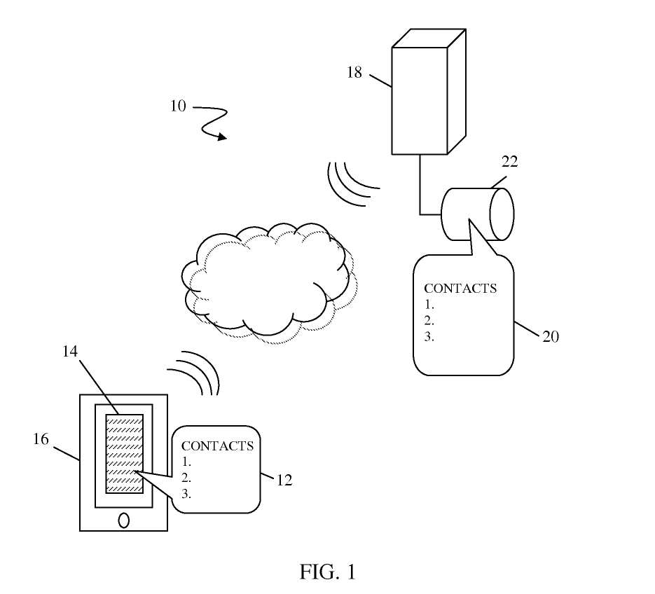

Referring now to the drawings, wherein like reference numerals refer to like parts throughout, there is seen in FIG. 1 a schematic of a cloud-based system 10 for securely maintaining phone numbers and contacts. More particularly, a mobile device user has a mobile application 14 on a single mobile device 16 having a phonebook 12, such as a contact list with names, numbers, addresses, email addresses, etc., and interfaces with a remotely positioned server 18 accessible via the internet or “cloud.” User 12 can create a primary phonebook 20 in the cloud by registering a new account in a database 22 associated with server 18 and establishing a secure user name and password. On the first login, user 12 may be provided with the option to sync all locally stored contact information 12 from mobile device 16 to the remote phonebook 20 maintained by server 18. A secure code and or authentication will be assigned. Support for fingerprint recognition and other forms of secure identification supported by the mobile device will be enabled. It should be recognized that a user may upload contact information from sources other than a particular mobile device, such as by providing server 18 with email accounts, contact data files from desktop email applications, etc.

Once contacts are encrypted, packed and uploaded over a secure https connection to remote phonebook 20 which is stored over the cloud in an encrypted and compressed format, locally stored contact information is deleted and, when a user desired to access his or her contacts, mobile application 14 may be used to import or access contact information in remote phonebook 20 so that user can display and/or use the contact information to place a call, send a message, etc. Upon closing mobile application 14, any locally stored copies of contact information in the device RAM from remote phonebook 20 are deleted. Thus, any other individual accessing mobile device 16 that is able to access mobile device 16, even through improper means, will not be able to access locally stored contact information (as none exists) and will not be able to access remotely stored contact information as a separate username and password must be provided before mobile application 14 will be provided with contact information by server 18. When a session, access to the remote phonebook 20 is active, the remote phonebook 20 will not be accessible to other devices. Any attempts at accessing is logged and notified to the current accessing device user.

To use system 10, a user installs mobile application 14 and logs in using verified information/credentials. All information stored on server 18 and synced to the private account in the cloud is downloaded and decrypted to the mobile devices' random access memory, to be used by the mobile application 14 and ready for access. User 12 may then search for the contact information and proceed accordingly. When user 12 is finished, user 12 logs out, the session is logged and all data stored locally on mobile device 16, such as in device RAM, is synced with the remote phonebook 20 and then erased from the device RAM. Preferably, if a session is left open and not logged out within the specified time, it automatically syncs with the remote phonebook 20 and logs out and deletes all information stored in device RAM. Upon log out, or timeout, the phonebook information that is stored in the device temporary memory is flushed and all traces erased. No data is permanently stored in the device storage.

During an active session, if another user tries to access the account with server 18, that user will be blocked and may receive a warning, such as “This session is not authorized, the owner has been informed.” When an unauthorized session is attempted, authorized user 12 will receive a warning that another user has attempted to create a session and from what device such an attempt was made. If it is a registered device, the device name will be displayed, if not, system 10 may report that an unrecognized device has attempted to access server 18. Authorized user then has the option of changing password credentials as the security of the user's phonebook may be compromised.

What is claimed is:

1. A secure phonebook system, comprising:
a mobile device having a mobile application installed thereon that is programmed to require a user to enter session credentials and to transmit those session credentials when said mobile application is opened;
a remotely positioned server interconnected to a database, wherein said server is programmed to store data representing said at least one contact and user credentials associated with said stored data, and is further programmed to transmit said data to said mobile device when said mobile application provides session credentials that match stored user credentials;
wherein said mobile application is programmed to display said data representing at least one contact only after said mobile application is opened and has received said data representing at least one contact from said server and to delete said data representing at least one contact each time said mobile application is closed.

2. The system of claim 1, wherein said server is programmed to accept session credentials that match user credentials from just one mobile application at a time.

3. The system of claim 2, wherein said server is programmed to notify said mobile application if the server receives a second transmission of matching session credentials.

4. The system of claim 1, wherein said mobile application is further programmed to connect to said remotely positioned server at least once and upload all contact information stored on said mobile device to said remotely positioned server.

5. The system of claim 4, wherein said mobile application is further programmed to delete said contact information from said mobile device after uploading to said remotely positioned server.

6. The system of claim 5, wherein said remotely positioned server is programmed to upload contact information from sources other than said mobile device.

7. A method of securing contact information used on a mobile device, comprising the steps of:
providing a mobile application for a mobile device that is programmed to require a user to enter session credentials and to transmit those session credentials when said mobile application is opened;
providing a remotely positioned server interconnected to a database, wherein said server is programmed to store data representing said at least one contact and user credentials associated with said stored data, and is further programmed to transmit said data to said mobile device when said mobile application provides session credentials that match stored user credentials;
using said mobile application to display said data representing at least one contact only after said mobile application is opened and has received said data representing at least one contact from said server; and
deleting said data representing at least one contact each time said mobile application is closed.

8. The method of claim 7, wherein said server is programmed to accept session credentials that match user credentials from just one mobile application at a time.

9. The method of claim 8, further comprising the step of providing a notification to said mobile device if the server receives a second transmission of matching session credentials.

10. The method of claim 7, further comprising the step of uploading all contact information stored on said mobile device to said remotely positioned server.

11. The method of claim 8, further comprising the step of deleting said contact information from said mobile device after uploading to said remotely positioned server.

12. The method of claim 7, further comprising the step of uploading contact information from sources other than said mobile device.

13. A method of securely providing contact information, comprising the steps of:
allowing a user to access a dedicated contact database stored on a remotely positioned server from a mobile device;
providing the user with contact information stored on said remotely positioned server in said dedicated contact database;
allowing said user to use said contact information to initiate a communication; and
automatically deleting all copies of said contact information stored on said mobile device.

14. The method of claim 13, wherein the step of allowing a user to access a dedicated user file stored on a remotely positioned server from a mobile device comprising the step of requiring said user to provide predetermined credentials unique to the user.

15. The method of claim 14, further comprising the step of notifying said user if another user provides said predetermined credentials after said user has provided said credentials and has accessed said dedicated contact database.

16. The method of claim 13, further comprising the steps of:
allowing a user to establish said dedicated contact database on said remotely positioned server;
allowing said user to establish said predetermined credentials unique to the user; and
associating said predetermined credentials unique to the user with said dedicated contact database.

17. The method of claim 16, further comprising the step of allowing said user to upload locally stored contact information from said mobile device to populate said dedicated contact database on said remotely positioned server.

18. The method of claim 17, further comprising the step of deleting said locally stored contact information on said mobile device after said dedicated contact database on said remotely positioned server has been populated with said contact information.
